(19) United States
(12) Patent Application Publication
(10) Pub. No.: US 2025/0271923 A1
(43) Pub. Date: Aug. 28, 2025

(54) INFORMATION PROCESSING APPARATUS AND CONTROL METHOD

(71) Applicant: Lenovo (Singapore) Pte. Ltd., Singapore (SG)

(72) Inventors: Masashi Nishio, Kanagawa (JP); Yuji Wada, Kanagawa (JP); Liheng Mo, Kanagawa (JP)

(73) Assignee: Lenovo (Singapore) Pte. Ltd., Singapore (SG)

(21) Appl. No.: 19/067,577

(22) Filed: Feb. 28, 2025

(30) Foreign Application Priority Data
Feb. 28, 2024 (JP) 2024-028787

(51) Int. Cl. G06F 1/3287; G01S 13/04; G01S 15/04; G01S 17/04; G06F 1/3206

(52) U.S. Cl. CPC G06F 1/3287; G01S 13/04; G01S 15/04; G01S 17/04; G06F 1/3206

(57) ABSTRACT

An information processing apparatus includes a sensor for detecting an object present within a predetermined detection range, and when it is detected using the sensor that any object with a certain movement is not present within the predetermined detection range over a first time, it is detected that no person is present within the predetermined detection range, and first information indicating that no person is present is set before the first time passes. In response to the first information being set, the measurement of a second time is started by system processing, and function stop processing to stop at least some of functions by the system processing is performed on conditions that it is detected that any object with a certain movement is not present within the detection range over the first time, and the measurement of the second time ends.

### CROSS-REFERENCE TO RELATED APPLICATIONS

### Background of the Invention

This application claims priority to Japanese Patent Application No. 2024-028787 filed on Feb. 28, 2024, the contents of which are hereby incorporated herein by reference in their entirety.

### Field of the Invention

Embodiments of the present invention relate to an information processing apparatus and a control method.

### Description of the Related Art

There is a device which makes a transition to a usable state when a person approaches or to a standby state in which functions except some of the functions are stopped when the person moves away. For example, in Japanese Unexamined Patent Application Publication No. 2016-148895, a technique for detecting the strength of infrared light using an infrared sensor to detect whether or not a person is approaching or has moved away in order to control the operating state of the device. Further, in recent years, with the development of computer vision and the like, detection accuracy when detecting a face from an image has been getting higher. Therefore, face detection is starting to be used instead of person detection by the infrared sensor.

In the case of person detection by the infrared sensor, a method of excluding motionless objects from detection targets may be taken to prevent just an object from being detected as a person. On the other hand, even in the case of person detection using face detection, since a face in a poster or the like may also be detected, the method of excluding motionless objects from detection targets may also be taken in the same way.

### SUMMARY OF THE INVENTION

If adding, to person detection conditions, the presence or absence of movement of a target to be detected as described above, the possibility of falsely detecting, as a person, an object that is not the person can be reduced, but on the other hand, the detection takes some time. Although the detection time varies depending on the detection target environment such as the presence or absence of a moving object other than a person, and whether or not a poster with a face image therein is put on a wall, the detection time is approximately 0 to 120 seconds, and there is a typical case where it takes about 40 seconds to perform the detection.

By the way, in recent years, there has been a tool that can set, in system settings such as Windows (registered trademark), a period of time from when the absence of a person is detected until the screen of a display unit is turned off, and display a setting time until the screen is turned off. However, since timekeeping of the setting time is started after the absence of a person is detected under the system side control, when the detection of the absence of a person takes time, there is a case of making a big difference between a period of time from when the person has actually left until the screen is turned off, and the setting time.

One or more embodiments of the invention provide an information processing apparatus and a control method capable of reducing a difference between a period of time from when a person has left until control on the system side is performed, and a setting time for the control set on the system side.

In accordance with one or more embodiments, an information processing apparatus according to the first aspect of the present invention includes: a sensor for detecting an object present within a predetermined detection range; a memory which temporarily stores a program of a system; and a processor which executes processing of the system based on the program and processing using the sensor, wherein the processor performs person detection processing in which, when detecting that any object with a certain movement is not present within the detection range using the sensor over a first time, the processor detects that no person is present within the detection range and sets first information indicating that no person is present before the first time passes, timekeeping processing to start measuring a second time by the system processing in response to the first information being set by the person detection processing, and function stop processing to stop at least some of functions by the system processing on conditions that it is detected by the person detection processing that any object with a certain movement is not present within the detection range over the first time, and the measurement of the second time by the timekeeping processing ends.

The above information processing apparatus may be such that, in the person detection processing, when detecting that an object with a certain movement is present within the detection range before the first time passes, the processor changes the setting from the first information to second information indicating that a person is present.

The above information processing apparatus may also be such that, in the person detection processing, when detecting that an object with a certain movement is present within the detection range before the first time passes, the processor resets the second time measured by the timekeeping processing.

The above information processing apparatus may further be such that, when stopping at least some of the functions by the system processing, the processor controls a display unit to be turned off.

Further, the above information processing apparatus may be such that the first information set by the person detection processing of the processor before the first time passes is a tentative setting to start measuring the second time, and when detecting that any object with a certain movement is not present within the detection range by the person detection processing over the first time, the detection that no person is present indicated by the first information is confirmed.

Further, the above information processing apparatus may be such that the first time is a time defined in the person detection processing, and the second time is settable by a user in the system.

Further, a control method according to the second aspect of the present invention is a control method for an information processing apparatus including: a sensor for detecting an object present within a predetermined detection range; a memory which temporarily stores a program of a system; and a processor which executes processing of the system based on the program and processing using the sensor, the control method including: a person detection step in which, when detecting that any object with a certain movement is not present within the detection range using the sensor over a first time, the processor detects that no person is present within the detection range and sets first information indicating that no person is present before the first time passes; a timekeeping step of causing the processor to start measuring a second time by the system processing in response to the first information being set by the person detection step; and a function stop step of causing the processor to stop at least some of the functions by the system processing on conditions that it is detected by the person detection step that any object with a certain movement is not present within the detection range over the first time, and the measurement of the second time by the timekeeping step ends.

The above-aspects of the present invention can reduce a difference between a period of time from when a person has left until control on the system side is performed, and a setting time for the control set on the system side.

### BRIEF DESCRIPTION OF THE DRAWINGS

FIGS. 1A-1C are diagrams for describing an overview of HPD processing of an information processing apparatus according to one or more embodiments.

FIG. 2 is a perspective view illustrating a configuration example of the appearance of the information processing apparatus according to one or more embodiments.

FIG. 3 is a diagram illustrating an example of a person detection range of the information processing apparatus according to one or more embodiments.

FIG. 4 is a diagram illustrating an example of screen off processing when detecting the leave of a person according to one or more embodiments.

FIG. 5 is a schematic block diagram illustrating an example of the hardware configuration of the information processing apparatus according to one or more embodiments.

FIG. 6 is a schematic block diagram illustrating an example of the functional configuration of the information processing apparatus according to one or more embodiments.

FIG. 7 is a flowchart illustrating an example of processing when detecting the leave of a person according to one or more embodiments.

### DETAILED DESCRIPTION OF THE INVENTION

An embodiment of the present invention will be described below with reference to the accompanying drawings.

### Overview

First, the overview of an information processing apparatus 1 according to one or more embodiments will be described. The information processing apparatus 1 according to the present embodiment is, for example, a laptop PC (Personal Computer). Note that the information processing apparatus 1 may also be any other type of information processing apparatus such as a desktop PC, a tablet terminal device, or a smartphone.

The information processing apparatus 1 can make a transition, as the operating state of the system, at least between a normal operating state (power-on state) and a standby state. The normal operating state is an operating state capable of executing processing without being particularly limited, which corresponds, for example, to SO state defined in the ACPI (Advanced Configuration and Power Interface) specification. The standby state is a state in which at least some of functions by system processing are limited. For example, the standby state is a state in which at least the screen of a display unit is turned off (screen off). The screen off means that the display is stopped to turn the display screen off (the display screen is hidden) to make the screen brightness become minimum (zero). Note that the screen brightness of the display unit in the normal operating state before the screen is turned off is called “standard brightness.”

Note that the standby state may be the standby state or a sleep state, Modern Standby in Windows (registered trademark), or a state corresponding to S3 state (sleep state) defined in the ACPI specification.

In the following, a transition of the system operating state from the standby state to the normal operating state may also be called “boot.” Since the standby state is generally lower in the activation level of the operation than the normal operating state, the boot of the system of the information processing apparatus 1 leads to the activation of the operation of the system in the information processing apparatus 1.

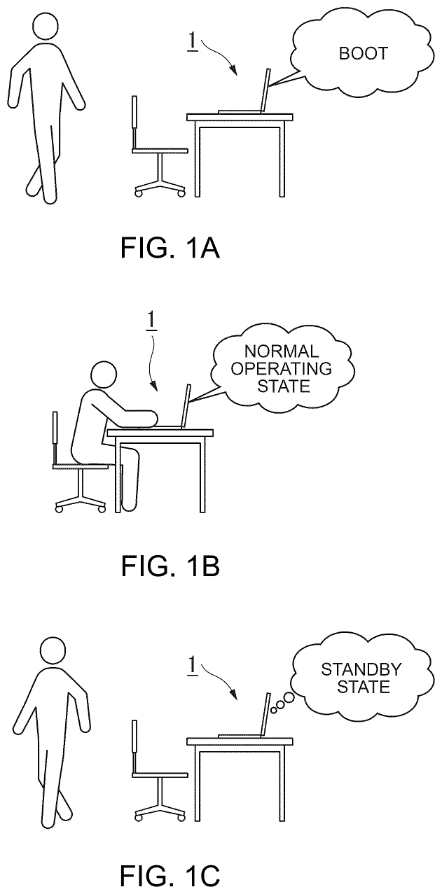

FIGS. 1A-1C are diagrams for describing an overview of HPD processing of the information processing apparatus 1 according to the present embodiment. The information processing apparatus 1 detects a person (that is, a user) present in the neighborhood of the information processing apparatus 1. This person detection processing to detect the presence of a person is called HPD (Human Presence Detection) processing. The information processing apparatus 1 detects the presence or absence of a person by the HPD processing to control the operating state of the system of the information processing apparatus 1 based on the detection result. For example, as illustrated in FIG. 1A, when detecting a change from a state where no person is present in front of the information processing apparatus 1 (Absence) to a state where a person is present (Presence), that is, when detecting that a person has approached the information processing apparatus 1 (Approach), the information processing apparatus 1 determines that the user has approached, and automatically boots the system to make a transition to the normal operating state. Further, in a state where a person is present in front of the information processing apparatus 1 (Presence) as illustrated in FIG. 1B, the information processing apparatus 1 determines that the user is present and continues the normal operating state. Then, as illustrated in FIG. 1C, when detecting a change from the state where the person is present in front of the information processing apparatus 1 (Presence) to the state where no person is present (Absence), that is, when detecting that the person has left the information processing apparatus 1 (Leave), the information processing apparatus 1 determines that the user has left, turns off the screen, and causes the system to make a transition to the standby state.

### Appearance Configuration of Information Processing Apparatus

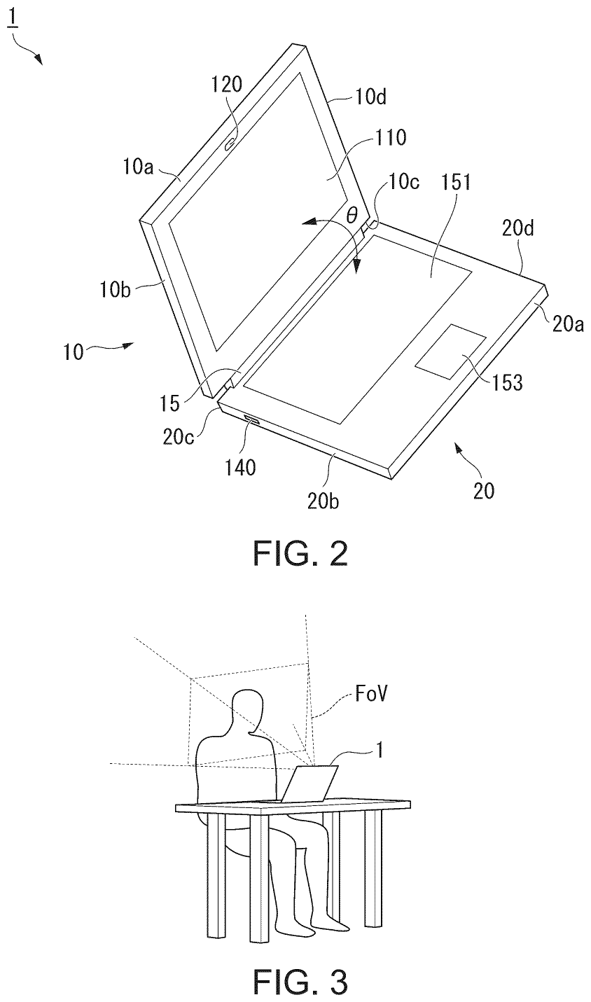

FIG. 2 is a perspective view illustrating an appearance configuration example of the information processing apparatus 1 according to the present embodiment. The information processing apparatus 1 includes a first chassis 10, a second chassis 20, and a hinge mechanism 15. The first chassis 10 and the second chassis 20 are joined by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “θ” in FIG. 2.

The first chassis 10 is also called A cover or a display chassis. The second chassis 20 is also called C cover or a system chassis. In the following description, faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” The right hand and the left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0°)is referred to as a “closed state.” Surfaces of the first chassis 10 and the second chassis 20 on the face-to-face side in the closed state are referred to as respective “inner surfaces,” and surfaces opposite to the inner surfaces are referred to as “outer surfaces.” Further, a state opposite to the closed state, where the first chassis 10 and the second chassis 20 are open, is referred to as an “open state.”

The appearance of the information processing apparatus 1 in FIG. 2 illustrates an example of the open state. The open state is a state where the side face 10a of the first chassis 10 and the side face 20a of the second chassis 20 are separated. In the open state, the respective inner surfaces of the first chassis 10 and the second chassis 20 appear. The open state is one of states where the user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15 or the like.

A display unit 110 is provided on the inner surface of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner surface of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can face a direction (frontward) to face the inner surface of the first chassis 10.

In the open state, the imaging unit 120 images a predetermined imaging range in the direction (frontward) to face the inner surface of the first chassis 10. The predetermined imaging range is a range of angles of view defined by an image sensor included in the imaging unit 120 and an optical lens provided in front of the imaging surface of the image sensor. For example, the imaging unit 120 can capture an image including a person present in front of the information processing apparatus 1.

Further, a power button 140 is provided on the side face 20b of the second chassis 20. The power button 140 is an operating element used by the user to give an instruction to power on or power off, make the transition from the standby state to the normal operating state, make the transition from the normal operating state to the standby state, or the like. Further, a keyboard 151 and a touch pad 153 are provided on the inner surface of the second chassis 20 as an input device to accept user operation input. Note that a touch sensor may also be provided as the input device instead of or in addition to the keyboard 151 and the touch pad 153, or a mouse and an external keyboard may be connected. When the touch sensor is provided, an area corresponding to the display surface of the display unit 110 may be constructed as a touch panel to accept operations. Further, a microphone used to input voice may be included in the input device.

Note that, in the closed state where the first chassis 10 and the second chassis 20 are closed, the display unit 110 and the imaging unit 120 provided on the inner surface of the first chassis 10, and the keyboard 151 and the touch pad 153 provided on the inner surface of the second chassis 20 are covered with each other's chassis surfaces, and put in a state of being disabled from fulfilling the functions.

The information processing apparatus 1 detects the presence of a person in a predetermined forward range.

FIG. 3 is a diagram illustrating an example of a person detection range of the information processing apparatus 1 according to the present embodiment. In the illustrated example, a detection range FoV (Field of View: detection viewing angle) in front of the information processing apparatus 1 is a person detectable range. For example, the information processing apparatus 1 detects a face area with a face captured therein from a captured image captured by imaging forward (the front side) to determine whether or not a person (user) is present in front of the information processing apparatus 1. The detection range FoV corresponds to an imaging angle of view at which the information processing apparatus 1 captures an image. When the face area is detected from the captured image, the information processing apparatus 1 determines that the user is present. On the other hand, when no face area is detected from the captured image, the information processing apparatus 1 determines that the user is not present.

Here, when detecting a face area from a captured image, the information processing apparatus 1 determines whether or not there is a movement in the face area so that a face in a poster or the like is not detected, and excludes a motionless object(s) from person detection targets. Note that, even when there is a movement exceeding in size and speed far beyond normal shaking and movement of a person (user) who uses the information processing apparatus 1, the information processing apparatus 1 also excludes it from the person detection targets. Thus, the information processing apparatus 1 detects whether or not a person is present in the detection range FoV by not only detecting the face area from the captured image, but also determining whether or not there is a certain movement in the detected face area (face). In other words, the information processing apparatus 1 detects whether or not a person is present in the detection range FoV depending on whether or not an object (for example, a face) with a certain movement is present in the detection range FoV.

In order to detect the presence or absence of a person by determining the presence or absence of a movement, it takes time depending on the situation. For example, when an image of a poster with a face image therein is captured within the detection range FoV, the detection tends to take time. For example, if it takes about 40 seconds to detect the leave of a person, the information processing apparatus 1 will take about 40 seconds from when the person has actually left until the leave of the person is detected by the HPD processing.

Meanwhile, there is a tool that can set, in settings on the side of the OS (Operating System) such as Windows (registered trademark), a period of time from when the absence of a person is detected until the screen of the display unit 110 is turned off, and the setting time until the screen is turned off is displayed. The timekeeping of the setting time on the OS side is started after the absence of a person is detected. For example, when this setting time is set to 30 seconds, if the timekeeping of the setting time is started after the leave of the person is detected (after the absence of the person is detected), it will take about 70 seconds from when the person has actually left until the screen is turned off. In this case, it is undesirable because there is a big difference from the setting time (30 seconds) and hence it is considered to give a sense of discomfort to the user or remind the user of a problem.

Therefore, even when it takes time (for example, about 40 seconds) to detect the leave of the person, the information processing apparatus 1 according to the present embodiment notifies the OS side that no person is present by assuming that the person has left during the detection before the detection time passes. Thus, the start of posting the setting time on the OS side can be advanced to reduce the period of time from when the person has actually left until the screen is turned off in order to reduce the difference from the setting time (30 seconds).

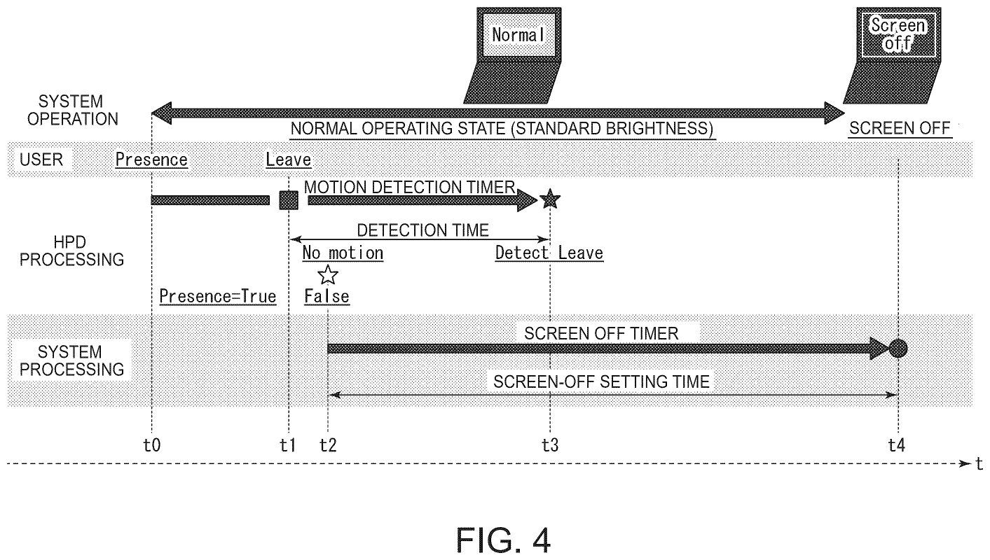

FIG. 4 is a diagram illustrating an example of screen off processing when detecting the leave of a person according to the present embodiment. This figure illustrates system operation when detecting the leave of a person, the user state, HPD processing, and system processing (processing on the OS side) in chronological order with the horizontal axis as time (t).

At time t0, the user is present in front of (within the detection range FoV of) the information processing apparatus 1. The information processing apparatus 1 is in the normal operating state and the screen brightness of the display unit 110 is the standard brightness. Since the presence of the person within the detection range FoV is already detected by the HPD processing, the information processing apparatus 1 sets “Presence=True” as the detection result of the HPD processing.

When the user leaves at time t1, the information processing apparatus 1 is put in a state of not detecting any object with a certain movement within the detection range FoV by the HPD processing (No motion), and timekeeping driven by a timer (hereinafter called the “motion detection timer”) to measure how long the state lasts is started. The motion detection timer is reset every time an object with a certain movement is detected.

When the timekeeping driven by the motion detection timer ends without detecting any object with a certain movement within the detection range FoV by the HPD processing (time t3), the information processing apparatus 1 detects that the person has left (Leave). In other words, when detecting that any object with a certain movement is not present within the detection range FoV over the detection time (for example, 40 seconds) measured by the motion detection timer, the information processing apparatus 1 detects that no person is present within the detection range FoV.

Further, the information processing apparatus 1 sets the detection result of the HPD processing to “Presence =False” indicating that no person is present at time t2 before detecting the leave of the person at time t3. For example, time t2 is set to 10 seconds after the motion detection timer starts timekeeping at time t1. In other words, when detecting that any object with a certain movement is not present within the detection range FOV for 10 seconds, the information processing apparatus 1 sets “Presence=False” before confirming that the person has left (Leave).

In response to “Presence=False” being set by the HPD processing, the information processing apparatus 1 starts measuring the setting time until the screen is turned off by the system processing (processing on the OS side). The timer to measure the setting time (screen-off setting time) until the screen is turned off is called a “screen off timer.” The screen off timer is reset without measuring time when the “Presence=True” is set, and starts measuring time in response to the fact that “Presence=False” is set.

Then, after time t3 at which the leave of the person is confirmed and on a condition that the measurement of the screen off timer ends, the information processing apparatus 1 turns the screen off by the system processing at time t4 and makes the transition to the standby state. Thus, when the information processing apparatus 1 is put into a state where any object with a certain movement is not detected (No motion), the information processing apparatus 1 can reduce the difference from the screen-off setting time, compared with the case where the timekeeping of the screen off timer is started at time t3, because the timekeeping of the screen off timer is started at time t2 before detecting (confirming) that the person has left (Leave) at time t3. For example, when the screen-off setting time is set to 30 seconds, if the timekeeping of the screen off timer is started at time t3, the period of time from when the person has actually left until the screen is turned off will be 70 seconds. In contrast to this, since the timekeeping of the screen off timer is started at time t2 and hence the period of time from when the person has actually left until the screen is turned off is 40 seconds, the difference from the screen-off setting time can be reduced and the information processing apparatus 1 is preferable.

Further, after setting “Presence=False” at time t2, when an object with a certain movement is detected within the detection range FoV by the HPD processing before time t3, the information processing apparatus 1 changes the setting to “Presence=True” and resets the motion detection timer. Thus, even when setting “Presence=False” before detecting (confirming) the leave of the person, since the information processing apparatus 1 will restore the setting to “Presence=True” if the person has not left (if the presence of the person is detected), the screen is prevented from being turned off falsely even though the person does not leave.

Note that the period of time from time t1 to time t2 is set as the minimum time t0 detect the state where any object with a certain movement is not detected (No motion), which is described as 10 seconds as an example, but the minimum time is not limited to 10 seconds. The period of time from time t1 to time t2 may be any period of time shorter than that from time t1 to time t3. However, as the period of time from time t1 to time t2 is shorter, the effect of reducing the difference between the period of time from when the person has actually left until the screen is turned off, and the screen-off setting time increases. Even in a case where the period of time from time t1 to time t2 is shortened, when an object with a certain movement is detected during the period of time from time t2 to time t3, there is no problem because the setting is restored to “Presence=True.”

Further, it is preferred that the period of time from time t1 to time t3 (detection time) is set to the same time as the screen-off setting time, or shorter than the screen-off setting time. By setting such a period of time, the timekeeping of the screen off timer is prevented from ending before the leave of the person is detected (confirmed).

### Hardware Configuration of Information Processing

Apparatus

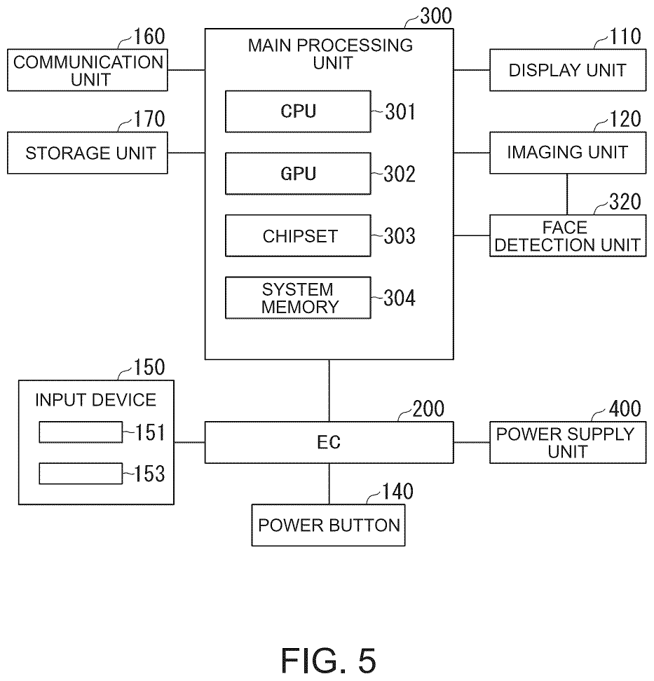

FIG. 5 is a schematic block diagram illustrating an example of the hardware configuration of the information processing apparatus 1 according to the present embodiment. In FIG. 5, components corresponding to respective units in FIG. 2 are given the same reference numerals. The information processing apparatus 1 is configured to include the display unit 110, the imaging unit 120, the power button 140, an input device 150, a communication unit 160, a storage unit 170, an EC (Embedded Controller) 200, a main processing unit 300, a face detection unit 320, and a power supply unit 400.

The display unit 110 displays display data (images) generated based on system processing executed by the main processing unit 300, processing of an application program(s) running on the system processing, and the like.

The imaging unit 120 captures an image of an object within a predetermined imaging range (angle of view) in a direction (frontward) to face the inner surface of the first chassis 10, and outputs the captured image to the main processing unit 300 and the face detection unit 320. For example, the imaging unit 120 is a visible light camera (RGB camera) to capture an image using visible light. Note that the imaging unit 120 may further include an infrared camera (IR camera) to capture an image using infrared light.

The power button 140 outputs, to the EC 200, operation signals according to user operations. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of the operation details.

The communication unit 160 is connected to other devices communicably through a wireless or wired communication network to transmit and receive various data. For example, the communication unit 160 is configured to include a wired LAN interface such as the Ethernet (registered trademark), a wireless LAN interface such as Wi-Fi (registered trademark), and the like.

The storage unit 170 is configured to include storage media, such as an HDD (Hard Disk Drive) or an SSD (Solid State Drive), a RAM, a ROM, and the like. The storage unit 170 stores an OS, device drivers, various programs such as applications, and various data acquired by the operation of the programs.

The power supply unit 400 supplies power to each unit of the information processing apparatus 1 according to the operating state of each unit. The power supply unit 400 includes a DC (Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access memory), a ROM (Read Only Memory), an I/O (Input/Output) logic circuit, and the like. The CPU of the EC 200 reads a control program (firmware) prestored in the own ROM and executes the read control program to fulfill the functionality. The EC 200 operates independently of the main processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The main processing unit 300 is configured to include a CPU (Central Processing Unit) 301, a GPU (Graphic Processing Unit) 302, a chipset 303, and a system memory 304, where processing of various application programs is executable on the OS (Operating System) by system processing based on the OS.

The CPU 301 executes processing based on a BIOS program, processing based on the OS program, processing based on application programs running on the OS, and the like. The CPU 301 controls the operating state of the system under the control of the chipset 303. For example, the CPU 301 executes boot processing to cause the operating state of the system to make the transition from the standby state to the normal operating state. Further, the CPU 301 executes processing to cause the operating state of the system to sleep off the display unit 110 and make the transition to the standby state from the normal operating state.

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection result by face detection processing from the face detection unit 320, and the like. For example, the chipset 303 executes HPD processing to detect a person (user) based on information acquired from the face detection unit 320, and the like.

The system memory 304 is used as a reading area of a program executed by the CPU 301 and a working area to write processed data. Further, the system memory 304 temporarily stores image data of captured images captured by the imaging unit 120.

Note that the CPU 301, the GPU 302, and the chipset 303 may also be integrated as one processor, or some or each of them may be configured as an individual processor, respectively. For example, in the normal operating state, the CPU 301, the GPU 302, and the chipset 303 are all operating, but in the standby state, only at least some of the functions of the chipset 303 are operating. In the standby state, at least only functions required for HPD processing upon bootup are operating.

The face detection unit 320 is configured to include a processor for processing image data of a captured image captured by the imaging unit 120. The face detection unit 320 acquires the image data of the captured image captured by the imaging unit 120, and temporarily stores the acquired image data in a memory. The memory in which the image data is stored may be the system memory 304, or a memory connected to the above processor included in the face detection unit 320.

For example, the face detection unit 320 processes the image data of the captured image acquired from the imaging unit 120 to perform face detection processing for detecting a face area from the captured image, processing based on the detection result by the face detection processing, and the like.

### Functional Configuration of Information Processing Apparatus

Next, a functional configuration related to HPD processing in the information processing apparatus 1 will be described in detail.

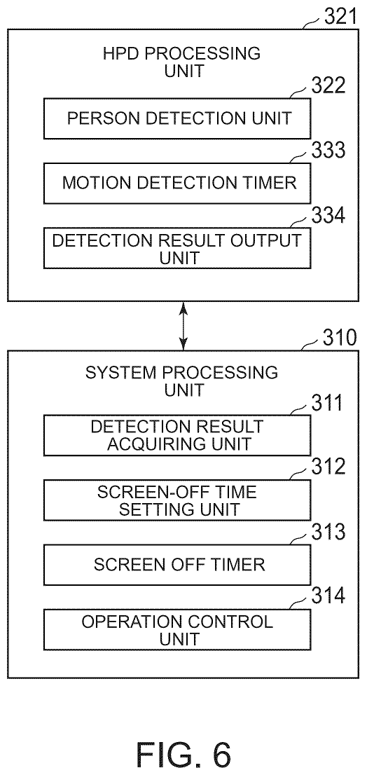

FIG. 6 is a schematic block diagram illustrating an example of the functional configuration of the information processing apparatus 1 according to the present embodiment. The information processing apparatus 1 includes a system processing unit 310 and an HPD processing unit 321.

The HPD processing unit 321 is a functional component to execute HPD processing (person detection processing) by processing of the face detection unit 320, or to execute processing of the face detection unit 320 and the chipset 303. For example, the HPD processing unit 321 includes a person detection unit 322, a motion detection timer 333, and a detection result output unit 334.

The person detection unit 322 detects whether or not a person is present within the detection range FoV based on a face area detected from a captured image acquired from the imaging unit 120. For example, the person detection unit 322 detects, using the imaging unit 120, whether or not an object (here, a face area) with a certain movement is present within the detection range FoV. When the face area with the certain movement exists, the person detection unit 322 detects that a person is present within the detection range FoV. When detecting that the person is present within the detection range FoV, the person detection unit 322 sets “Presence=True” as the detection result.

On the other hand, when detecting that any face area with a certain movement does not exist over a predetermined detection time (for example, the period of time from time t1 to time t3 in FIG. 4), the person detection unit 322 detects that no person is present within the detection range FoV. At this time, the person detection unit 322 measures the predetermined detection time using the motion detection timer 333.

Here, when detecting that no face area exists within the detection range FoV, the person detection unit 322 sets “Presence=False” (for example, at time t2 in FIG. 4) before the predetermined detection time (for example, the period of time from time t1 to time t3 in FIG. 4) passes. “Presence=False” set by this person detection unit 322 before the predetermined detection time passes is a tentative setting to start measuring the screen-off setting time. Then, when the existence of any face area with a certain movement is not detected by the person detection unit 322 within the detection range FoV (for example, at time t3 in FIG. 4) over the predetermined detection time (for example, the period of time from time t1 to time t3 in FIG. 4), the detection that no person is present as indicated by “Presence=False” is confirmed.

Note that, when detecting that a face area with a certain movement exists within the detection range FoV after “Presence=False” is set and before this predetermined detection time (for example, the period of time from time t1 to time t3 in FIG. 4) passes, the person detection unit 322 changes the setting from “Presence=False” to “Presence=True”. This predetermined detection time is the time determined in the HPD processing.

Further, when detecting that the face area with the certain movement exists within the detection range FoV after “Presence=False” is set and before this predetermined detection time (for example, the period of time from time t1 to time t3 in FIG. 4) passes, the person detection unit 322 resets the time measured by the motion detection timer 333.

As described with reference to FIG. 4, the motion detection timer 333 is a timer for measuring the predetermined detection time mentioned above (for example, the period of time from time t1 to time t3 in FIG. 4).

The detection result output unit 334 outputs, to the system processing unit 310, “Presence=True” or “Presence=False” set as the detection result of the person detection unit 322.

The system processing unit 310 is a functional component implemented by the CPU 301 executing OS system processing. For example, the system processing unit 310 includes a detection result acquiring unit 311, a screen-off time setting unit 312, a screen off timer 313, and an operation control unit 314 as functional components by OS processing.

The detection result acquiring unit 311 acquires “Presence=True” or “Presence=False” output from the HPD processing unit 321.

The screen-off time setting unit 312 sets the screen-off setting time based on a user operation or the like. For example, the screen-off setting time is settable by the user in the system settings of the OS.

When the detection result acquiring unit 311 acquires “Presence=False,” the screen off timer 313 starts measuring the screen-off setting time (for example, the period of time from time t2 to time t4 in FIG. 4) set by the screen-off time setting unit 312. In other words, the screen off timer 313 starts measuring the screen-off setting time by system processing in response to the fact that “Presence=False” is set by the person detection unit 322.

The operation control unit 314 controls system processing (the operating state and the like) based on the detection result by the HPD processing. For example, the operation control unit 314 stops at least some of the functions by the system processing on conditions that it is detected by the person detection unit 322 that any face area with a certain movement does not exist within the detection range FoV over the predetermined detection time (for example, the period of time from time t1 to time t3 in FIG. 4), and the measurement of the screen-off setting time (for example, the period of time from time t2 to time t4 in FIG. 4) by the screen off timer 313 ends. As an example, when stopping at least some of the functions by the system processing, the operation control unit 314 performs control to turn off the screen of the display unit 110 and make the transition to the standby state.

### Operation of Processing When Detecting Leave of Person

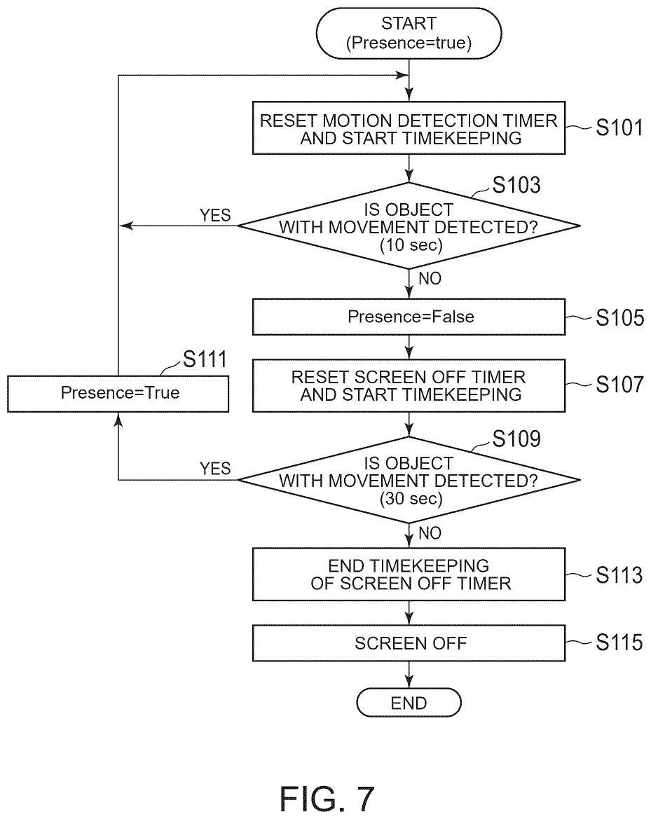

Referring next to FIG. 7, the operation of processing when the information processing apparatus 1 detects the leave of a person by the HPD control processing will be described.

FIG. 7 is a flowchart illustrating an example of processing when detecting the leave of a person according to the present embodiment. Here, it is assumed that the information processing apparatus 1 is in the normal operating state and “Presence=True” is set.

(Step S101) The HPD processing unit 321 resets the motion detection timer 333 and starts timekeeping of the detection time. Then, the HPD processing unit 321 proceeds to a process in step S103.

(Step S103) The HPD processing unit 321 detects whether or not an object (here, a face area) with a certain movement is present within the detection range FoV. Then, the HPD processing unit 321 determines whether or not the object (here, the face area) with the certain movement is detected within the detection range FoV for 10 seconds measured by the motion detection timer 333. When determining that the object (here, the face area) with the certain movement is detected (YES), the HPD processing unit 321 returns to the process in step S101. On the other hand, when determining that the object (here, the face area) with the certain movement is not detected (NO), the HPD processing unit 321 proceeds to a process in step S105.

(Step S105) The HPD processing unit 321 sets “Presence=False” (tentative setting) to start timekeeping by the screen off timer 313, and outputs “Presence=False” to the system processing unit 310. Then, the procedure proceeds to a process in step S107.

(Step S107) When acquiring “Presence=False” output from the HPD processing unit 321, the system processing unit 310 resets the screen off timer 313 to start timekeeping of the screen-off setting time. Then, the procedure proceeds to a process in step S109.

(Step S109) Continuing from the process in step S103, the HPD processing unit 321 determines whether or not an object (here, a face area) with a certain movement is detected within the detection range FoV for 30 seconds measured by the motion detection timer 333. When determining that an object (here, a face area) with a certain movement is detected (YES), the HPD processing unit 321 proceeds to a process in step S111, and returns to the process in step S101 after changing the setting to “Presence=True.” On the other hand, when determining that any object (here, any face area) with a certain movement is not detected (NO), the HPD processing unit 321 confirms the detection that no person is present (“Presence=False”), and the procedure proceeds to a process in step S113.

(Step S113) The system processing unit 310 ends the timekeeping of the screen-off setting time by the screen off timer 313, and proceeds to a process in step S115.

(Step S115) The system processing unit 310 turns off the screen of the display unit 110 and makes the transition to the standby state.

### Summary of Embodiment

As described above, the information processing apparatus 1 according to the present embodiment includes: the imaging unit 120 (an example of a sensor) for detecting an object (for example, a face) present within a predetermined detection range FoV; the system memory 304 (an example of a memory) which temporarily stores a program of a system (for example, the OS); and a processor (for example, the CPU 301, the chipset 303, the face detection unit 320, or the like) which executes processing of the system based on the above program and processing using the imaging unit 120. The information processing apparatus 1 performs HPD processing (person detection processing) in which, when detecting that any object (for example, any face) with a certain movement is not present within the detection range FoV using the imaging unit 120 over a predetermined detection time (an example of a first time), the information processing apparatus 1 detects that no person is present within the detection range FoV and sets “Presence=False” (an example of first information) indicating that no person is present before the predetermined detection time passes. Further, the information processing apparatus 1 performs timekeeping processing to start measuring a screen-off setting time (an example of a second time) by the system processing in response to “Presence=False” being set by the HPD processing. Then, the information processing apparatus 1 performs function stop processing to stop at least some of the functions (for example, screen off) by the system processing on conditions that it is detected by the HPD processing that any object (for example, any face) with a certain movement is not present within the detection range FoV over the predetermined detection time, and the measurement of the screen-off setting time by the timekeeping processing ends.

Thus, when detecting that no person is present within the detection range FoV, since the information processing apparatus 1 starts timekeeping of the screen-off setting time before the time required for the detection passes, a difference between a period of time from when a person has left until control on the system side is performed, and a setting time for the control set on the system (OS) side can be reduced.

Further, in the HPD processing, when detecting an object (for example, a face) with a certain movement is present within the detection range FoV before the predetermined detection time passes, the information processing apparatus 1 changes the setting from “Presence=False” to “Presence=True” (an example of second information) indicating that a person is present.

Thus, when detecting that no person is present within the detection range FoV, if the presence of a person is detected before the time required for the detection passes, the information processing apparatus 1 can detect the presence of the person correctly.

Further, in the HPD processing, when detecting that an object (for example, a face) with a certain movement is present within the detection range FOV before the predetermined detection time passes, the information processing apparatus 1 resets the screen-off setting time measured by the timekeeping processing.

Thus, when detecting that no person is present within the detection range FoV, if the presence of a person is detected before the time required for the detection passes, the information processing apparatus 1 can perform control correctly not to turn off the screen of the display unit 110.

Further, when stopping at least some of the functions by the system processing, the information processing apparatus 1 controls the screen of the display unit 110 to be turned off (OFF).

Thus, the information processing apparatus 1 can turn off the screen of the display unit 110 when the person has left to reduce power consumption. Further, since the content being displayed on the display unit 110 becomes invisible to others when the person has left, the information processing apparatus 1 can improve security.

Here, “Presence=False” set by the information processing apparatus 1 in the HPD processing before the predetermined detection time passes is a tentative setting for starting the measurement of the screen-off setting time. Further, when it is detected by the HPD processing that any object (for example, any face) with a certain movement is not present within the detection range FoV over the predetermined detection time, the detection that no person is present indicated by “Presence=False” is confirmed.

Thus, when detecting that no person is present within the detection range FoV, the information processing apparatus 1 can tentatively set “Presence=False” before the time required for the detection passes to start measuring the screen-off setting time without waiting for confirmation of the detection. Therefore, the information processing apparatus 1 can reduce the difference between the period of time from when the person has left until control on the system (OS) side is performed, and the setting time for the control set on the system side.

The predetermined detection time is a time defined in the HPD processing, and the screen-off setting time is settable by the user in the system.

Thus, the information processing apparatus 1 can suppress the influence on the user due to a discrepancy between the detection time in the HPD processing and the screen-off setting time set by the user on the system (OS) side.

Further, a control method according to the present embodiment is a control method for the information processing apparatus 1 including: the imaging unit 120 (the example of the sensor) for detecting an object (for example, a face) present within a predetermined detection range FoV; the system memory 304 (the example of the memory) which temporarily stores a program of a system (for example, the OS); and a processor (for example, the CPU 301, the chipset 303, the face detection unit 320, or the like) which executes processing of the system based on the above program and processing using the imaging unit 120, the control method including: a person detection step in which, when detecting that any object (for example, any face) with a certain movement is not present within the detection range FoV using the imaging unit 120 over a predetermined detection time (the example of the first time), the processor detects that no person is present within the detection range FoV and sets “Presence=False” (the example of the first information) indicating that no person is present before the predetermined detection time passes; a timekeeping step of causing the processor to start measuring a screen-off setting time (the example of the second time) by the system processing in response to the “Presence=False” being set by the person detection step; and a function stop step of causing the processor to stop at least some of the functions (for example, screen off) by the system processing on conditions that it is detected by the person detection step that any object (for example, any face) with a certain movement is not present within the detection range FoV over the predetermined detection time, and the measurement of the screen-off setting time by the timekeeping step ends.

Thus, when detecting that no person is present within the detection range FoV, since the control method for the information processing apparatus 1 starts timekeeping of the screen-off setting time before the time required for the detection passes, a difference between a period of time from when a person has left until control on the system side is performed, and a setting time for the control set on the system (OS) side can be reduced.

While one or more embodiments of this invention have been described in detail above with reference to the accompanying drawings, the specific configurations are not limited to those described above, and design changes and the like are included without departing from the scope of this invention. For example, the respective components described in the embodiments mentioned above can be combined arbitrarily.

Further, in one or more of the aforementioned embodiments, the configuration example in which the imaging unit 120 is built in the information processing apparatus 1 is described, but the present invention is not limited to this example. For example, the imaging unit 120 does not have to be built in the information processing apparatus 1, which may also be attachable to the information processing apparatus 1 (for example, onto any one of the side faces 10a, 10b, 10c, and the like) and communicably connected to the information processing apparatus 1 wirelessly or by wire as an external accessory of the information processing apparatus 1.

Further, in one or more of the aforementioned embodiments, the information processing apparatus 1 detects a face area with a face captured therein from a captured image to detect the presence of a person, but the presence of a person may also be detected using a distance measuring sensor for measuring the distance to an object. For example, the distance measuring sensor is provided on the inner surface side of the first chassis 10 to detect an object present within the detection range in the direction to face the inner surface of the first chassis 10. Like in the aforementioned embodiment, even when the distance measuring sensor is used, an object with a certain movement over the predetermined detection time can be detected as a person. As an example, the distance measuring sensor may be a ToF (Time of Flight) sensor that emits infrared light forward in a predetermined sampling cycle (for example, 1 Hz) and receives the reflected light of the emitted infrared light to convert, into a distance, a time difference from light emission to light reception.

Note that the distance measuring sensor may be a sensor using infrared light emitted by a light emitting diode, or a sensor using infrared laser that emits a light beam narrower in wavelength band than the infrared light emitted by the light emitting diode. Further, the distance measuring sensor is not limited to the distance measuring sensor using infrared light, and a sensor using any other method such as an ultrasonic sensor or a sensor using UWB (Ultra Wide Band) radar may be used as long as the sensor detects the distance to an object. Further, the distance measuring sensor does not have to be built in the information processing apparatus 1, which may also be attachable to the information processing apparatus 1 (for example, onto any one of the side faces 10a, 10b, 10c, and the like) and communicably connected to the information processing apparatus 1 wirelessly or by wire as an external accessory of the information processing apparatus 1. Further, the imaging unit 120 and the distance measuring sensor may be constructed integrally.

Further, the CPU 301 (an example of a first processor) and the chipset 303 (an example of a second processor) may be constructed as individual processors, or may be integrated as one processor.

Further, in one or more of the aforementioned embodiments, the example in which the face detection unit 320 is provided separately from the main processing unit 300 is given, but some or all of the functions of the face detection unit 320 may be constructed integrally with the main processing unit 300. Further, some or all of the functions of the face detection unit 320 may be provided in any processor (the CPU 301 or the chipset 303) provided in the main processing unit 300, or may be constructed integrally with any processor (the CPU 301 or the chipset 303) provided in the main processing unit 300. Further, some or all of the functions of the face detection unit 320 may be provided in the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 1, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of the information processing apparatus 1 in one or more embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of the aforementioned embodiment is not limited to a PC, a tablet terminal device, a smartphone, or the like, which may also be a gaming device, a multimedia terminal, or the like.

### DESCRIPTION OF SYMBOLS

1 information processing apparatus
10 first chassis
20 second chassis
15 hinge mechanism
110 display unit
120 imaging unit
140 power button
150 input device
151 keyboard
153 touch pad
160 communication unit
170 storage unit
200 EC
300 main processing unit
301 CPU
302 GPU
303 chipset
304 system memory
310 system processing unit
311 detection result acquiring unit
312 screen-off time setting unit
313 screen off timer
314 operation control unit
321 HPD processing unit
322 person detection unit
333 motion detection timer
334 detection result output unit
400 power supply unit

What is claimed is:

1. An information processing apparatus comprising:
a sensor for detecting an object present within a predetermined detection range;
a memory which temporarily stores a program of a system; and
a processor which executes processing of the system based on the program and processing using the sensor, wherein the processor performs
person detection processing in which, when detecting that any object with a certain movement is not present within the detection range using the sensor over a first time, the processor detects that no person is present within the detection range and sets first information indicating that no person is present before the first time passes,
timekeeping processing to start measuring a second time by the system processing in response to the first information being set by the person detection processing, and
function stop processing to stop at least some of functions by the system processing on conditions that it is detected by the person detection processing that any object with a certain movement is not present within the detection range over the first time, and the measurement of the second time by the timekeeping processing ends.

2. The information processing apparatus according to claim 1, wherein in the person detection processing, when detecting that an object with a certain movement is present within the detection range before the first time passes, the processor changes the setting from the first information to second information indicating that a person is present.

3. The information processing apparatus according to claim 1, wherein in the person detection processing, when detecting that an object with a certain movement is present within the detection range before the first time passes, the processor resets the second time measured by the timekeeping processing.

4. The information processing apparatus according to claim 1, wherein when stopping at least some of the functions by the system processing, the processor controls a display unit to be turned off.

5. The information processing apparatus according to claim 1, wherein
the first information set by the person detection processing of the processor before the first time passes is a tentative setting to start measuring the second time, and
when detecting that any object with a certain movement is not present within the detection range by the person detection processing over the first time, the detection that no person is present indicated by the first information is confirmed.

6. The information processing apparatus according to claim 1, wherein
the first time is a time defined in the person detection processing, and
the second time is settable by a user in the system.

7. A control method for an information processing apparatus including: a sensor for detecting an object present within a predetermined detection range; a memory which temporarily stores a program of a system; and a processor which executes processing of the system based on the program and processing using the sensor, the control method comprising:
a person detection step in which, when detecting that any object with a certain movement is not present within the detection range using the sensor over a first time, the processor detects that no person is present within the detection range and sets first information indicating that no person is present before the first time passes;
a timekeeping step of causing the processor to start measuring a second time by the system processing in response to the first information being set by the person detection step; and
a function stop step of causing the processor to stop at least some of the functions by the system processing on conditions that it is detected by the person detection step that any object with a certain movement is not present within the detection range over the first time, and the measurement of the second time by the timekeeping step ends.
